(19) United States
(12) Patent Application Publication
(10) Pub. No.: US 2009/0142679 A1
(43) Pub. Date: Jun. 4, 2009

(54) CONDUCTIVE MEMBER, PROCESS CARTRIDGE USING THE CONDUCTIVE MEMBER, AND IMAGE FORMING DEVICE USING THE PROCESS CARTRIDGE

(75) Inventors: Tadayuki OSHIMA, Atsugi-shi (JP); Hiroki Furubayashi, Atsugi-shi (JP); Taisuke Tokuwaki, Sagamihara-shi (JP); Yutaka Narita, Sagamihara-shi (JP); Makoto Nakamura, Ebina-shi (JP); Satoshi Terashima, Isehara-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD, TOKYO (JP)

(21) Appl. No.: 12/274,126

(22) Filed: Nov. 19, 2008

(30) Foreign Application Priority Data
Nov. 29, 2007 (JP) 2007-309236

(51) Int. Cl. G03G 15/00

(52) U.S. Cl. 430/56

(57) ABSTRACT

A conductive member includes a conductive supporting body, an electrostatic resistance adjusting layer formed on the conductive supporting body, and a space holding member, which is formed on each of both end portions of the electric resistance adjusting layer, has a material different from a material of the electric resistance adjusting layer, and constantly maintains a space between the electric resistance adjusting layer and the image carrier, wherein the electric resistance adjusting layer comprises a resin composition including thermoplastic resin containing at least polyamide elastomer and polyolefin block polymer and plural types of salt containing at least one type of salt selected from perchlorate and at least one type of salt selected from fluorine-containing organic anion salt.

### PRIORITY CLAIM

The present application is based on and claims priority from Japanese Patent Application No. 2007-309236, filed on Nov. 29, 2007, the disclosure of which is hereby incorporated by reference in its entirety.

### BACKGROUND OF THE INVENTION

1. Field of the Invention

The present invention relates to a conductive member, a process cartridge using the conductive member, and an image forming device using the process cartridge.

2. Description of the Related Art

In an image forming device having an electrophotographic process such as a copier, a laser printer, or a facsimile, a conductive member is conventionally used as a charging member, which performs a charging process to a photoconductive drum as an image carrier, and a transfer member, which conducts a transfer process to toners on the photoconductive drum.

FIG. 1 is a schematic view illustrating an image forming device. This image forming device includes a photoconductive drum 11 onto which an electrostatic image is formed, a charging roller 12 as a charging member, which conducts a charging process to the photoconductive drum 11, a development roller 14, which adheres the toners 15 onto the electrostatic latent image of the photoconductive drum 11, a transfer roller 16, which transfers the toner image on the photoconductive drum 11 to a recording medium 17, and a cleaning member 21 having a cleaning blade 18, which cleans the photoconductor drum 11 after the transfer process. In addition, reference number 19 denotes toners removed from the photoconductive drum 11 by the cleaning, and reference number 20 denotes a developing unit. In FIG. 1, functional units generally required for another electrophotographic process are omitted.

When forming an image by the image forming device, a surface 11a of the photoconductive drum 11 is charged to a negative high potential by the charging roller 12.

Next, this surface 11a is exposed to exposure light. By this exposure light, an electric potential distribution according to the amount of light received is generated on the surface 11a. Thereby, an electrostatic latent image is formed on the surface 11a.

Next, if the photoconductive drum 11 rotates, and a part of the surface 11a onto which the electrostatic latent image is formed passes through the development roller 14, the toners adhere onto the surface 11a according to the electric potential distribution, and the electrostatic latent image on the surface 11a is thereby visualized as a toner image.

Then, the toner image is transferred by the transfer roller 16 onto the recording medium 17 which is fed at a predetermined timing. The recording medium 17 onto which the toner image is transferred is fed to the arrow B direction toward a fixing unit (not shown).

After transferring the toner image onto the recording medium 17, the toners remaining on the surface 11a of the photoconductive drum 11 are removed by a cleaning blade 18, so as to clean the surface 11a of the photoconductive drum 11, and also the electric charge is eliminated by a quenching lamp (not shown), so as to prepare for the next image forming process.

A contact charging method, which brings the charging roller 12 into contact with the photoconductive drum 11, is known as a general charging method in the image forming device (for example, refer to JP S63-149668A, JP H01-211779A, and JP H01-267667A).

However, the contact charging method has the following problems.

(1) A component of the charging roller 12 exudes from the charging roller 12, and is firmly fixed onto the surface 11a of the photoconductive drum 11. If this fixation is developed, the track of the charging roller 12 remains on the surface 11 a of the photoconductive drum 11.

(2) When applying an alternating voltage to the charging roller 12, the charging roller 12 which has contact with the photoconductive drum 11 vibrates, resulting in vibration noise.

(3) The toners on the surface 11a of the photoconductive drum 11 are firmly fixed onto the charging roller 12, resulting in the decrease in the charging performance. Especially, if the component of the charging roller 12 described in the above (1) exudes, the fixation of the toners is developed. As a result, the charging performance is significantly deteriorated.

(4) The component of the charging roller 12 is easily fixed onto the photoconductive drum 11.

(5) If the photoconductive drum 11 does not drive for a long period of time, the charging roller 12 permanently deforms.

In order to address the above problems, a close charging method, which brings the charging roller 12 closer to the photoconductive drum 11 without bringing the charging roller 12 into contact with the photoconductive drum 11, is proposed (refer to JP H03-240076A, for example). In the close charging method, the distance of closest approach (hereinafter, referred to as a space) between the charging roller 12 and the photoconductive drum 11 is set to 50 μm to 300 μm. If a voltage is applied to the charging roller in a state in which the charging roller 12 faces the photoconductive drum 11, the photoconductive drum 11 is charged. In this close charging method, since the charging roller 12 does not have contact with the photoconductive drum 11, the above problems (1), (3), (4), (5) of the contact charging method are solved.

The charging roller 12 for use in the contact charging method has a structure of a cored bar covered with an elastic body such as a vulcanized rubber. In this contact charging method, it is required that the charging roller 12 uniformly has contact with the photoconductive drum 11, in order to uniformly charge the photoconductive drum 11.

On the other hand, in the close charging method, when the charging roller 12 is constituted by an elastic body similar to the contact charging method in order to uniformly charge the photoconductive drum 11, the following problems are caused.

(1) A space is formed between the photoconductive drum 11 and the charging roller 12 by providing space holding members such as spacers in both sides of the charging roller 12, respectively. However, since the charging roller 12 is made of the elastic body, it is difficult to uniformly maintain the space because of the deformation of the elastic body. As a result, displacement in the charged potential and an uneven image resulting from the displacement are caused.

(2) The vulcanized rubber material which forms the elastic body deteriorates with age and easily deforms. Accordingly, the size of the space changes over time.

(3) In order to solve the above problems, it is considered to use thermoplastic resin which is a non-elastic body for the charging roller 12. If the thermoplastic resin is used for the charging roller 12, the space between the photoconductive drum 11 and the charging roller 12 is uniformly maintained.

In the meantime, it is known that the charging mechanism of the surface 11a of the photoconductive drum 11 by the charging roller 12 is a discharge mechanism according to Paschen's Law by micro discharge between the charging roller 12 and the photoconductive drum 11. It is necessary for the electric resistance value of the thermoplastic resin (electric resistance adjusting layer) of the charging roller 12 to be set to a semi-conductive property (about 10⁶ Ωcm-10⁹ Ωcm), in order to maintain the photoconductive drum 11 at a predetermined charged potential. As a control method of this electric resistance value, a method of dispersing a conductive pigment such as carbon black in thermoplastic resin is known.

If the thermoplastic resin (electric resistance layer) is provided with a semi-conductive property by using conductive pigment, the variations in the electric resistance values are increased. As a result, a charging error is partially caused or a local discharge (leak discharge) is caused by electrical conduction, which causes an image error.

On the other hand, as another method of controlling an electrical resistance value of thermoplastic resin (electric resistance adjusting layer), it is considered to use an ion-conductive material. Since the ion-conductive material disperses in the thermoplastic resin (matrix resin) on the molecular level, compared to the case when the conductive pigment is used, the variations in the resistance values are decreased. In this case, a partial charging error is caused, but such a charging error is not a problem relative to an image quality.

However, a low-molecular-weight ion-conductive material such as electrolyte salt has a property which easily bleeds out (exudes) on the surface of the thermoplastic resin. For this reason, the toners are firmly fixed onto the surface of the charging roller 12, resulting in an image error. In order to avoid this bleeding out, it is considered to use a high-molecular form ion-conductive material. Since the high-molecular form ion-conductive material disperses and fixes in the thermoplastic resin, it hardly bleeds out on the surface.

As the high-molecular form ion-conductive material, polyamide series elastomer or the like is used. However, since the resistance value of the thermoplastic resin (electric resistance adjusting layer) is high, the thermoplastic resin (electric resistance adjusting layer) can not be provided with the semi-conductive property by using only the high-molecular form ion-conductive material. For this reason, a method of applying a preferable conductive performance to the thermoplastic resin (electric resistance adjusting layer) by adding the electrolyte salt in the high-molecular form ion-conductive material is used. As the electrolyte salt, perchlorate such as sodium perchlorate or lithium perchlorate, or fluorine-containing organic anion salt such as organic phosphonium salt or trifluoromethanesulfonatelithium (for example, refer to JP 2005-85601) is used.

However, in the high-molecular form ion-conductive material, hydrogen ion and hydroxide ion in a circumferential atmosphere meditate in a conductive path, so the conductive property is significantly influenced by the water volume in the air. Especially, the conductive property is extremely decreased in a low -temperature and low-humidity environment, so the uneven dispersion of the high-molecular form ion-conductive material and the electrolyte salt in the electric resistance adjusting layer is most obvious as the difference of the conductive property. As a result, the discharge from the charging roller 12 to the photoconductive drum 11 becomes uneven, causing an image error. In order to prevent the uneven discharge in the low-temperature and low-humidity environment, it is necessary to increase the conductive property of the electric resistance adjusting layer so as to improve a discharge margin. However, the conductive property is not significantly realized by the perchlorate or the fluorine-containing organic anion salt. Therefore, the generation of the uneven discharge is an inevitable problem.

### SUMMARY OF THE INVENTION

Consequently, the present inventors have found that the discharge margin is improved by adding the perchlorate and the fluorine-containing organic anion salt as the electrolyte salt in the high-molecular form ion-conductive material, so that the uneven discharge is not generated in the low-temperature and low-humidity environment. They also have found that when only the perchlorate is added to the high-molecular form ion-conductive material, the decrease in the conductive property by the polarization of the electrolyte salt is large by the power distribution of use with age, and when the conductive member is used for a long period of time, the above-described uneven discharge was generated, but when both of the perchlorate and the fluorine-containing organic anion salt are added to the high-molecular form ion-conductive material, the decrease in the conducive property by the power distribution is small, so that a high discharge margin is maintained, and the uneven discharge is not generated even if the conductive member is used for a long period of time.

More particularly, they have found that when the perchlorate and the fluorine-containing organic anion salt are added to the high-molecular form ion-conductive material, the discharge margin is significantly improved, so that an image error by the discharge is not caused even if the conductive member is used for a long period of time.

The present invention has been made in view of the above-described problems, and an object of the present invention is to provide a conductive member which has a high discharge margin and controls an image error by uneven discharge in a low-temperature and low-environment even if it is used for a long period of time, a charging member to which this conductive member is applied, a process cartridge using the charging member and an image forming device using the process cartridge.

In order to achieve the above object, a first aspect of the present invention relates to a conductive member including a conductive supporting body, an electrostatic resistance adjusting layer formed on the conductive supporting body, and a space holding member, which is formed on each of both end portions of the electric resistance adjusting layer, is made of a material different from a material of the electric resistance adjusting layer, and constantly maintains a space between the electric resistance adjusting layer and the image carrier, wherein the electric resistance adjusting layer comprises a resin composition including thermoplastic resin containing at least polyamide elastomer and polyolefin block polymer and plural types of salt containing at least one type of salt selected from perchlorate and at least one type of salt selected from fluorine-containing organic anion salt.

Preferably, the fluorine-containing organic anion salt is at least one or more type of salt selected from trifluoromethanesulfonatelithium, bis(trifluoromethanesulfonyl) imide lithium and tris(trifluoromethanesulfonyl) methide lithium.

Preferably, graft copolymer with an affinity for the thermoplastic resin is melted and kneaded.

Preferably, the graft copolymer is a graft copolymer including main-chain polycarbonate resin and side-chain acrylonitrile-styrene-glycidyl methacrylate copolymer.

Preferably, the conductive member charges the image carrier.

A second aspect of the present invention relates to a process cartridge comprising the above-described conductive member.

A third aspect of the present invention relates to an image forming device comprising the above-described process cartridge.

### BRIEF DESCRIPTION OF THE DRAWINGS

The accompanying drawings are included to provide further understanding of the invention, and are incorporated in and constitute a part of this specification. The drawings illustrate embodiments of the invention and, together with the specification, serve to explain the principle of the invention.

FIG. 1 is a schematic view illustrating an image forming device.

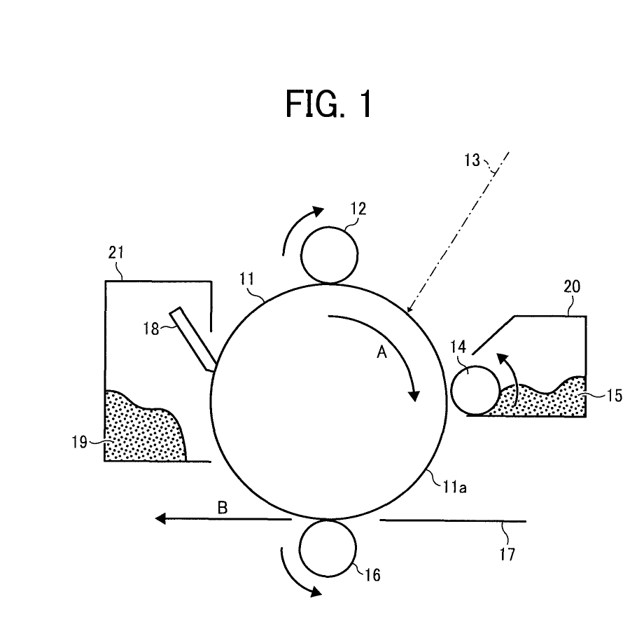

FIG. 2 is a schematic view illustrating a structure of an image forming device using a charging unit and a process cartridge when a conductive member according to an embodiment of the present invention is used as a charging member.

FIG. 3 is a schematic view illustrating an image forming section of the image forming device illustrated in FIG. 2.

FIG. 4 is a schematic view illustrating a structure of the charging unit and the process cartridge according to the embodiment of the present invention.

FIG. 5 is a schematic view illustrating a positional relationship among the charging member as the conductive member, a photosensitive layer area of an image carrier, an image forming area and a non-image forming area according to the embodiment of the present invention.

FIG. 6 is a graph illustrating a result of a test 2 and a temporal change in an electrical resistance of a conductive member obtained in each of embodiments 1-5 and comparative examples 1-4 under a low-temperature and low-humidity environment.

### DETAILED DESCRIPTION OF THE PREFERRED EMBODIMENTS

Hereinafter, an embodiment of the present invention will be described with reference to the accompanying drawings.

An image forming device 1 includes four image carriers (photoconductor) 61 corresponding to four colors, yellow (Y), magenta (M), cyan (C), and black (K), respectively, each of which has a drum shape having a photosensitive layer on its surface, four charging units 100 each of which uniformly charges the surface of each image carrier 61, an exposure unit 70 which exposes each of the charged image carriers 61 by means of a laser beam, so as to form an electrostatic latent image, four developing units 63 each of which houses each of four-color developers, yellow, magenta, cyan, and black, and forms a toner image corresponding to the electrostatic latent image of the image carrier 61, four primary transfer units 62 each of which transfers a toner image of the image carrier 61, a belt-shaped intermediate transfer body 50 to which the toner image of the image carrier 61 is transferred, a secondary transfer unit 51 which transfers the toner image of the intermediate transfer body 50 onto a recording medium (recording paper), a fixing unit which fixes the toner image of the recording medium, and four cleaning units 64 each of which eliminates toners remaining on each of the image carriers 61 after the transferring.

The recording paper is fed to a resist roller 23 one by one via a transport path from one of a plurality of paper feeding cassettes 21 which houses recording paper by means of a transport roller. In this case, the recording paper is fed to a transfer position in synchronization with the toner image on the image carrier 61.

The exposure unit 70 of the image forming device 1 irradiates a light L onto the image carrier 61 charged by the charging unit 100, so as to form an electrostatic latent image on the image carrier 61 having a photoconductive property. The light L can be a lamp such as a fluorescent light or a halogen lamp, or a laser light beam from a semiconductor element such as an LED or an LD. In this case, the exposure unit 70 irradiates in synchronization with a rotation speed of the image carrier 61 by signals from an image processor (not shown), and an LD is used.

The developing unit 63 includes a developer carrier, and transfers toners stored in the developing unit 63 to an agitation section by a supplying roller. The agitation section mixes the toners with the developer containing carriers, and agitates them, and the developing unit 63 transfers them to the development area which faces the image carrier 61. The toners are charged into a positive polarity or a negative polarity. The toners are transferred to the electrostatic latent image of the image carrier 61 and are developed. The developer may be a magnetic or non-magnetic monocomponent developer, or be a developer which uses the magnetic developer and non-magnetic monocomponent developer together.

The primary transfer unit 62 forms an electric field having a polarity opposite to a polarity of the toners, so as to transfer the developed toner image of the image carrier 61 onto the intermediate transfer body 50 from the back side of the intermediate transfer body 50. The primary transfer unit 62 may be a transfer unit such as a corona transfer unit of coroton or scoroton, a transfer roller or a transfer brush.

After that, the toner image is again transferred onto the recording medium by means of the secondary transfer unit 51 in synchronization with the recording medium fed from the paper feeding unit 22. In this case, the toner image can be directly transferred onto the recording medium without transferring onto the intermediate transfer body 50.

The fixing unit 80 fixes the toner image onto the recording medium by heating and/or pressing the toner image onto the recording medium. In this case, the recording medium passes through between a pair of pressure fixing rollers, and fixes the toner image while melting the tie resin of the toners by heating and pressing the recording medium. The fixing unit 80 having a roller shape may be a fixing unit having a belt shaped, or a fixing unit which fixes a toner image by means of heat illumination with a halogen lamp or the like.

The cleaning unit 64 of the image carrier 61 removes the toners remaining on the image carrier 61 without being transferred, and enables next image formation. The cleaning unit 64 may be a blade made of a rubber such as a urethane or a fur brush made of fiber such as polyester.

Next, the operation of the image forming device 1 according to the embodiment of the present invention will be described.

In a reading section 30, an original is set on a platen of an original feeding section 36, or an original is set on the contact glass 31 by opening the original feeding section 36, and the original is held by closing the original feeding section 36. Then, a start switch (not shown) is pressed, if the original is set in the original feeding section 36, a first moving stage 32 having a light source and a mirror and a second moving stage 33 having mirrors run after the original is fed to the contact glass 31, or if the original is set on the contact glass 31, the first and second moving stages 32, 33 immediately run.

The first moving stage 32 irradiates light from the light source, and reflects a reflection light from the original, so as to guide the reflected light to the second moving stage 33. Moreover, the reflection light from the original is reflected by the mirror of the second moving stage 33, so as to be guided to a focusing lens 34. Then, the light guided to the focusing lens 34 is focused on a light-receiving surface of a CCD 35 which is a reading sensor, so as to read the image information on the original. The read image information is sent to a controller. The controller controls an LD or an LED (not shown) disposed in the exposure unit 70 of the image forming section 60, and irradiates a laser light L for writing toward the image carrier 61. By the irradiation of this laser light L, an electrostatic latent image is formed on the surface of the image carrier 61.

The paper feeding section 20 takes out a recording medium by the paper feeding roller from the multi-stage paper feeding cassettes 21, feeds the taken out recording medium by separating the medium by a separation roller to a paper feeding path, and feeds the recording medium by the transfer roller to the paper feeding path of the image forming section 60. In addition to the paper feeding section 20, a recording medium can be manually fed. The image forming device includes on the side face thereof a tray for manually feeding a recording medium, and a separation roller which separates the recording media on the tray one by one toward the paper feeding path. The resist roller 23 discharges one recording medium placed in each of the paper feeding cassettes 21, and sends the recording medium to a secondary transfer section located between the intermediate transfer body 50 and the secondary transfer unit 51. In the image forming section 60, a latent image is formed on the image carrier 61 by conducting the above-described laser writing and development process after receiving the image information from the reading section 30.

The developer in the developing unit 63 is absorbed by a magnetic pole (not shown) to be retained, and forms a magnetic brush on the developer carrier. Moreover, the developer transfers onto the image carrier 61 by the development bias voltage applied to the developer carrier, and visualizes the electrostatic latent image on the image carrier 61, so as to form the toner image. The development bias voltage is a voltage in which an alternating voltage is superimposed with a direct voltage.

Next, one of the paper feeding rollers of the paper feeding section 20 is operated so as to feed a recording medium having a size corresponding to a size of the toner image. Associated with this operation, one of the supporting rollers is rotated by a driving motor, and another two supporting rollers are rotated, and the intermediate transfer body 50 is rotated. At the same time, monochromatic images of black, yellow, magenta, cyan are formed on the image carriers 61, respectively, by rotating the image carriers 61 in the image forming sections, respectively. The monochromatic images are sequentially transferred onto the intermediate transfer body 50, so as to form a composite image on the intermediate transfer body 50.

On the other hand, one of the paper feeding rollers of the paper feeding section 20 is selected and is rotated so as to take out recording media from one of the paper feeding cassettes 21. The recording media are separated one by one by the separation roller such that each recording medium is led to the paper feeding path. Then, the recording medium is led to the paper feeding path in the image forming section 60 of the image forming device 1 by the transfer roller, and the recording medium hits the resist roller 23 and stops. The resist roller 23 is rotated so as to be timed with the composite image on the intermediate transfer body 50, and the recording medium is sent to the secondary transfer section which is a contact section of the intermediate transfer body 50 and the secondary transfer unit 51. The toner image formed in the secondary transfer section is recorded on the recording medium by secondarily transferring the toner image with effects such as secondary transfer bias and contact pressure. In this case, it is preferable for the secondary transfer bias to be direct current. The recording medium after the image is transferred is sent to the fixing unit 80 by the transferring belt of the secondary transfer unit, and is discharged onto the discharge tray 40 by the discharge roller 41 after fixing the toner image by the pressure of the pressurizing roller and applying heat in the fixing unit 80.

Hereinafter, a case will be described when the conductive member according to the embodiment of the present invention is used as the charging member in the charging unit 100.

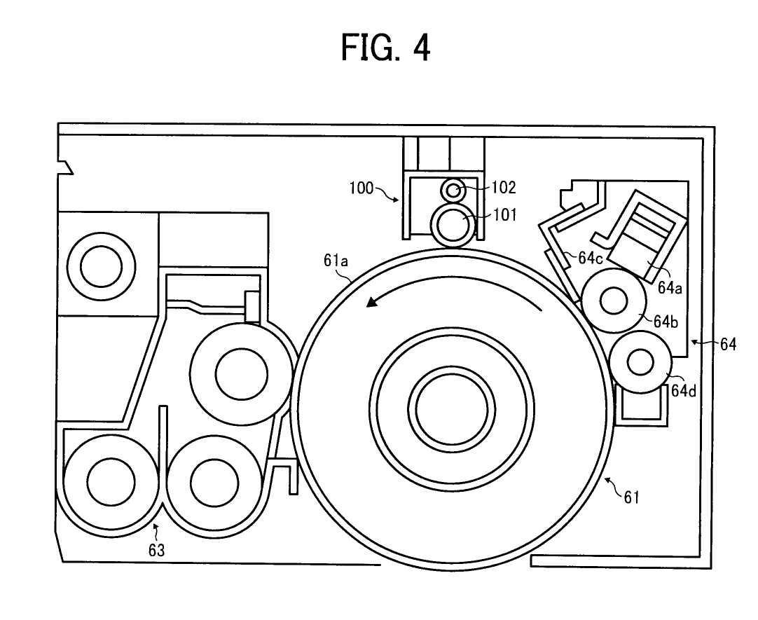

FIG. 4 is a schematic view illustrating the structures of the charging unit 100 and the process cartridge according to the embodiment of the present invention. The process cartridge includes the image carrier 61, the charging unit 100, and the cleaning unit 64. As illustrated in FIG. 4, the process cartridge may include the developing unit 63. The process cartridge can be attached to the image forming device 1 and removed from the image forming device 1.

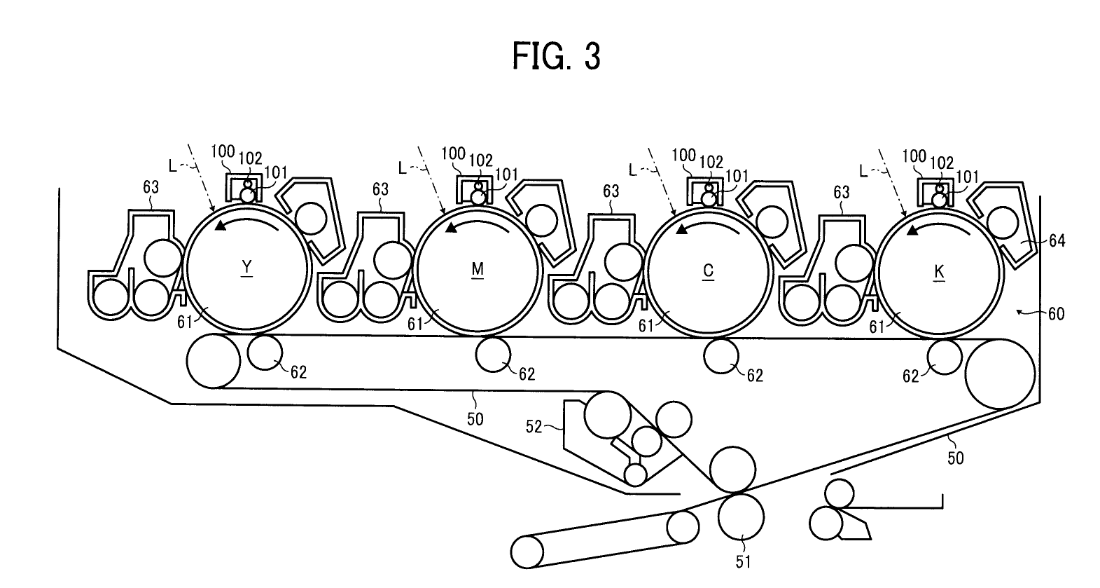

Referring to FIG. 3, the surface of the image carrier 61 is uniformly charged by the charging member 101 disposed in an image forming area of the surface of the image carrier 61 without having contact with the surface of the image carrier 61. An electrostatic latent image is formed on the surface of the image carrier 61 by the light L. This electrostatic latent image is visualized by developing, and the toner image is transferred onto the recording medium. The toners remaining on the image carrier 61 without being transferred on to the recording medium are collected by an auxiliary cleaning member 64d (refer to FIG. 4). After that, in order to prevent the toners and the materials of the toners from adhering onto the surface of the image carrier 61, solid lubricant 64a is uniformly applied onto the image carrier 61 by means of an applying member 64b so as to form a lubricant layer. After that, the toners which are not collected by the auxiliary cleaning member 64d are collected by a cleaning member 64c, and are transported to a discharge toner collecting section.

The auxiliary cleaning member 64d has a roller shape or a brush shape. As the solid lubricant, fatty acid metallic salt such as zinc stearate, polytetrafluoroethylene, or the like, which can apply a non-adherence property while reducing a friction coefficient on the image carrier 61, can be used. As the cleaning member, a blade made of rubber such as silicon or urethane, a fur brush made of fabric such as polyester, or the like can be used.

The charging unit 100 includes the cleaning member 102 for eliminating the contamination of the charging member 101. The shape of the cleaning member 102 may be a roller shape or a pad shape; however, in this embodiment, the shape of the cleaning blade 102 is a roller shape. The cleaning member 102 fits to shaft supporters 107 provided in a housing (not shown) of the charging unit 100, and is rotatably supported. This cleaning member 102 has contact with the charging member 101 so as to clean the outer circumferential face of the charging member 101. If foreign substances such as toners, powdered paper, and breakage of a member adhere onto the surface of the charging member 101, the electric field concentrates on the foreign substance portion, so that abnormal discharge, which causes the discharge by priority, is caused. On the other hand, if electrically insulating-foreign substances adhere in a wide area, the discharge is not caused in that area, so that a charged spot is generated on the image carrier 61. For this reason, it is preferable to dispose the cleaning member 102 which cleans the surface of the charging member 101 in the charging unit 100. A brush made of fabric such as polyester or a porous body (sponge) such as melamine resin can be used as the cleaning blade 102. The cleaning member 102 can be rotated associated with the rotation of the charging member 101, or can perform an intermittent operation which repeats contact and release.

The charging unit 100 includes a power source which applies a voltage to the charging member 101. It is possible to use only a direct voltage as the voltage; however, it is preferable to use a voltage in which a direct voltage is superimposed with an alternating voltage. When the charging member 101 has an uneven portion, the surface potential of the image carrier 61 may become uneven by applying only a direct voltage. However, if the superimposed voltage is applied, the surface potential of the charging member 101 becomes equal, and the image carrier can be uniformly charged because of the stabilized discharge. It is preferable for the alternating voltage in the superimposed voltage to have a voltage between peaks which is twice that at the start of charging of the image carrier 61. The voltage at the start of charging is an absolute value of a voltage when the image carrier is started to be charged when applying only the direct current to the charging member 101. Thereby, reverse discharge from the image carrier 61 to the charging member 101 is caused, and the image carrier 61 can be uniformly charged with a further stabilized state by the reverse discharge. It is also preferable for a frequency of the alternating voltage to be 7 times or more of the peripheral velocity (process speed) of the image carrier 61. By setting the frequency 7 times or more, a moire image disappears.

In the embodiment of the present invention, the auxiliary cleaning member 64d is a brush roller, and the solid lubricant 64a is zinc stearate which is formed into a block shape. By pressurizing the solid lubricant 64a by means of a pressurizing member such as a spring, the solid lubricant scraped from the solid lubricant 64a by the applying member 64b is applied to the image carrier 61.

The cleaning member 102 has a counter method using a urethane blade. This cleaning member 102 can clean the stain on the surface of the charging member 101 by using a sponge roller made of melamine resin which rotates along the rotation of the charging member 101.

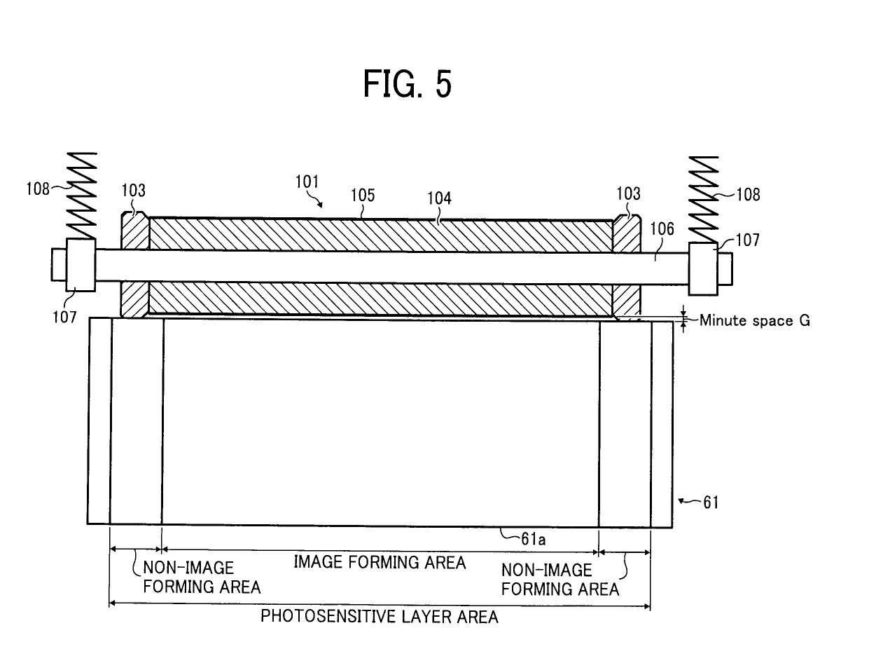

FIG. 5 is a schematic view illustrating the charging member 101 of the conductive member and a positional relationship of the photosensitive area, the image forming area and the non-image forming area of the image carrier 61.

The charging unit 100 includes the charging member 101 which is disposed to face the image carrier 61, the cleaning member 102 which cleans the charging member 101, the power source (not shown) which applies a voltage to the charging member 101, and a pressure spring (not shown) which pressurizes the charging member 101 so as to have contact with the image carrier 61.

As illustrated in FIGS. 4, 5, the charging member 101 is disposed to face the image carrier 61 via a minute space G between the charging member 101 and the image carrier 61. The space G between the charging member 101 and the image carrier 61 is formed by bringing space holding members 103, which are disposed coaxially with the charging member 101 in both end portions of the charging member 101, into contact with the non-image forming areas of the charging member 101. By the contact of the space holding members 103 to the photosensitive area, variations in the space can be prevented even if the application thickness of the photosensitive layer is varied.

As illustrated in FIG. 5, the charging member 101 includes a conductive supporting body (core shaft) 106, an electric resistance adjusting layer 104 formed on the conductive supporting body 106, and the space holding members disposed in both end portions of the electric resistance adjusting layer 104, respectively. The electric resistance adjusting layer 104 has on the surface thereof a surface layer 105 which prevents the toners and the toner additive agent from adhering onto the electric resistance adjusting layer 104.

The shape of the charging member 101 is not especially limited. It can be fastened in a belt shape, a blade (plate) shape or a semicircle shape. The charging member 101 can be a cylindrical shape having both ends rotatably supported by gears or shaft supports, respectively. As described, the charging member 101 is formed by a curved surface which gradually separates from the closest position to the image carrier 61 to the upstream and downstream directions of the moving direction of the image carrier 61, so that the image carrier 61 can be uniformly charged. If the charging member 101 facing the image carrier 61 has a sharp portion, the electrical potential of the sharp portion is increased. For this reason, the discharge starts from that portion, so that it becomes difficult to uniformly charge the image carrier 61. Accordingly, it is preferable for the charging member 101 to have a cylindrical shape having a curved surface. Thereby, the image carrier 61 can be uniformly charged.

The discharging surface of the charging member 101 is deteriorated by a strong load. The discharge always generates at the same portion, so the deterioration is developed, resulting in damage. If the charging member 101 includes a cylindrical shape and its entire surface is used as the discharge face, the development of the deterioration can be prevented by appropriately rotating the charging member 101, and the charging member 101 can be used for a long period of time.

The space G between the charging member 101 and the image carrier 61 is set to 100 μm or less, especially, about 5-70 μm by adjusting the diameter of the space holding member 103. The formation of an abnormal image can be thereby controlled in the operation of the charging device 100. When the space G is 100 μm or more, the distance in which the discharge reaches the image carrier 61 is increased, and the discharge start voltage of Paschen's Law is increased. If the discharge space is increased, a lot of discharge products by the discharge are required for charging the image carrier 61. These discharge products remain in the discharge space after forming an image, and adhere onto the image carrier 61, causing the development in the time degradation of the image carrier 61. When the space G is small, the distance in which the discharge reaches the image carrier 61 is short, and the image carrier 61 can be charged with small discharge energy. However, the discharge space is decreased, and the flow of air is deteriorated. For this reason, a lot of discharge products formed in the discharge space remain in the discharge space after forming an image similar to the situation of the large space G, and adhere onto the image carrier 61, resulting in the development in the time degradation of the image carrier 61. Therefore, it is preferable to reduce the generation of the discharge product by decreasing the discharge energy and to form a space having a size in which air does not remain in the discharge space. Accordingly, it is preferable for the space G to be 100 μm or less, especially, 5-70 μm. By this structure, the generation of the streamer discharge is prevented, and the generation of the discharge products can be decreased. Therefore, the amount of the discharge products which accumulate in the image carrier 61 can be reduced, and the generation of the image spot and image deletion can be prevented.

In this case, the toners remaining on the image carrier 61 after developing are cleaned by the cleaning unit 64 which is disposed to face the image carrier 61. However, it is difficult to completely remove the toners. Accordingly, a slight amount of toners pass through the cleaning unit 64, and are transported to the charging unit 100. In this case, if the particle diameter of the toner is larger than the space G, the toners are heated by the friction against the image carrier 61 and the charging member 101, and may be bonded to the charging member 101. In this case, the toner-bonded part gets closer to the image carrier 61, so that abnormal discharge occurs in which the discharge occurs by priority. Therefore, it is preferable for the space G to be larger than the maximum particle diameter of the toner for use in the image forming device 1.

As illustrated in FIGS. 4, 5, the charging member 101 fits to the shaft supporters 107, 107 disposed in the side plate of the housing (not shown) of the charging unit 100. However, even if the charging member 101 fits to the shaft supporters 107, the size of the space G changes by the vibration when rotating, the eccentricity of the charging member 101, and the asperity of the surface, and the size of the space G may be deviated from the appropriate range, resulting in the development in the deterioration of the image carrier 61. For this reason, the charging member 101 is pressed in the direction of the surface 61a of the image carrier 61 by compression springs 108 disposed in the shaft receivers 107, respectively, each of which does not drive with the shaft receiver 107 and is made of resin having a low friction coefficient. Therefore, even if the mechanical vibration and the displacement of the cored bar are caused, the space G having a predetermined size can be formed. The load which presses the charging member 101 by the compression spring 108 is set to 4-25N, preferably, 6-15N. In this case, the load means all load which is applied to the image carrier 61 via the space holding members 103.

This load can be adjusted by the strength of the compression springs 108 disposed in both ends of the charging member 101, the own weight of the charging member 101 and the cleaning member 102 and the like. If the load is small, the fluctuation of the charging member 101 in the rotation and the leaping of the charging member 101 by the impact of the driving gear can not be controlled. On the other hand, if the load is large, the friction between the charging member 101 and the shaft supporter 107 is increased. The temporal wear volume is thereby increased, so that the fluctuation of the charging member 101 is developed. Accordingly, it is preferable for the load to be set to 4-25N, more preferably to 6-15N, so as to set the size of the space G to the appropriate range. Therefore, the generation of the discharge product is decreased, the number of discharge products to be accumulated in the image carrier 61 is reduced, the operating life of the image carrier 61 is increased, and the generation of image spot and image deletion can be prevented.

The diameter of a part of the space holding member 103 is set to be larger than the diameter of the electric resistance adjusting layer 104. The space G can be formed by simultaneously processing the electric resistance adjusting layer 104 and the space holding members 103 with an elimination process such as a cutting process or a grinding process. By simultaneously processing the space holding members 103 and the electric resistance adjusting layer 104, the space G can be formed with high accuracy.

If the diameter of the space holding member 103 is set to be larger than the diameter of the electric resistance adjusting layer 104 in the side opposite to the electric resistance adjusting layer 104, and is gradually reduced as the space holding member 103 approaches the electric resistance adjusting layer 104, the contact width between the space holding member 103 and the image carrier 61 is reduced, and the space G between the conductive member 101 and the image carrier 61 can be maintained with high accuracy. Since the end portion of the space holding member 103 on the electric resistance adjusting layer 104 side does not have contact with the image carrier 61, the generation of leak current between the electric resistance adjusting layer 104 and the image carrier 61 via this end portion can be prevented. If the diameter of the space holding member 103 is set to be larger than the diameter of the electric resistance adjusting layer 104 on the side opposite to the electric resistance adjusting layer 104, and is processed to be reduced as the space holding member 103 approaches the electric resistance adjusting layer 104, the adjacent portion of the space holding member 103 and the electric resistance adjusting layer 104 can be a clearance of a cutting blade when conducting the elimination process. The shape of the clearance can be any shape as long as the end portion of the space holding member 103 on the electric resistance adjusting layer 104 side does not have contact with the image carrier 61. It is difficult to apply masking when coating the surface layer 105 to the adjacent portion of the electric resistance adjusting layer 104 and the space holding member 103 because of the variations. Therefore, when forming the adjacent portion of the electric resistance adjusting layer 104 and the space holding member 103, if the surface layer 105 is formed to the adjacent part of the electric resistance adjusting layer 104 and the space holding member 103, the surface layer 105 can be effectively formed on the electric resistance adjusting layer 104.

A necessary feature of the space holding member 103 is to stably maintain the space G between the photoconductive body 61 and the space holding member 103 for a long period of time without depending on environment. Accordingly, it is preferable for a material of the space holding member 103 to have a small hygroscopic property and a small abrasion-resistance property. It is also important that the toners and toner additive agent do not adhere to the space holding member 103, and the space holding member 103 does not wear the photoconductive body 61. The material of the space holding member 103 is appropriately selected according to the various conditions.

In particular, the material of the space holding member 103 includes general-purpose resin such as polyethylene (PE), polypropylene (PP), polyacetal (POM), polymethacrylmethacrylate (PMMA), or polystyrene (PS) and polystyrene copolymer (AS, ABS), polycarbonate (PC), urethane, or fluorine (PTFE). In order to effectively fasten the space holding member 103 to the electric resistance adjusting layer 104, an adhesive agent can be used. It is also preferable for the space holding member 103 to use an insulating material having a volume resistivity of 10¹³ Ωcm or more.

As described above, the space holding member 103 requires an insulating property so as to prevent the generation of the leak current between the space holding member 103 and the image carrier 61 as described above.

The electric resistance adjusting layer 104 includes thermoplastic resin (A) containing at least polyamide elastomer and polyolefin block polymer in the molecule, and a resin material containing perchlorate and fluorine-containing organic anion salt, in order to obtain a conductive function by ionic conduction.

The electric resistance adjusting layer 104 requires an ion conductive property because when an electronically conductive agent such as carbon black is used, the discharge is generated to the image carrier 61 via the electrically conductive agent, and minute discharge unevenness resulting from the dispersion condition of the electrically conductive agent is easily caused, which disturbs a high quality image. This phenomenon is especially remarkable when applying a high voltage.

The ion-conductive material includes low-molecular weight salt such as alkali metal salt or ammonium salt. However, such salt polarizes by power distribution and easily bleeds out. Accordingly, as a high-molecular form ion-conductive material, polyolefin block polymer or solid polyamide elastomer containing an ether group is used.

By containing an ether group in a molecule, the salt is stabilized by an oxygen atom or the like contained in the ether link, and a high conductive property can be obtained. In this structure, the ether group is uniformly dispersed and fixed at the molecular level in the matrix polymer, so the unevenness of the conductive property associated with a dispersion error as in a composition in which conductive pigment is dispersed is not caused. Since the high-molecular form ion-conductive material is a high-molecular form material, it hardly bleeds out. The high-molecular form ion-conductive material includes polyether polyols such as liquid polyethylene oxide or liquid polypropylene oxide containing an ether group. When a liquid high-molecular form ion-conductive material is used, a high-molecular form ion-conductive material can not be uniformly dispersed in the thermoplastic resin. Therefore, solid polyamide elastomer or solid polyolefin block polymer is required.

The polyamide elastomer and the polyolefin block polymer are broadly divided into a hydrophilic grade and a hydrophobic grade, and their structures significantly differ. Therefore, it is possible to blend a plurality of grades in order to obtain an objective feature.

However, the conductive property for using as the conductive member can not be obtained only by the thermoplastic resin containing the polyamide elastomer and the polyolefin block polymer. For this reason, electrolyte salt is used in combination with the thermoplastic resin, so as to improve the conductive property.

As an electrolyte salt, a perchlorate is the most common salt. In addition to the perchlorate, an organic phosphonium salt or a fluorine-containing organic anion salt is used.

However, in the conductive function by the ionic conduction, a reaction involving hydroxide ion and hydrogen ion in a peripheral atmosphere has a part of the conductive path. Therefore, the impact of the water volume in the air on the conductive performance is high and the environmental variation of the conductive property is very large. In particularly, the dispersion state of the ion-conductive material and the electrolyte salt in the electric resistance adjusting layer 104 appears as a difference of the conductive property under a low-temperature and low-humidity environment in which the decrease in the conductive property becomes remarkable.

As a result, the discharge from the charging roller 12 to the photoconductive body 61 becomes uneven, resulting in an image error. In particular, when an analogue half-tone image is output, such an error appears as a white dot. In order to prevent the uneven discharge under a low-temperature and low-humidity environment, it is necessary to increase the conductive property of the electric resistance adjusting layer 104 and to improve the discharge margin. However, the conductive property is not significantly applied only by the perchlorate and the organic phosphonium salt.

Conventionally, the generation of the uneven discharge was prevented by excessively increasing an applied voltage and a discharge current. However, by excessively applying a voltage, cracks by the deterioration in the power distribution of the electric resistance adjusting layer 104 and the adhesion of the increased discharge products to the conductive member are caused, resulting in the decrease in the resistance of the charging roller.

The present inventors have studied the formulation of the material of the electric resistance adjusting layer 104. As a result, the present inventors have found that the uneven discharge is not caused and the discharge margin is improved under a low-temperature and low-humidity environment by adding perchlorate and fluorine-containing organic anion salt.

When only the perchlorate is used, the electrolyte salt easily polarizes by the power distribution, and the decrease in the conductive property of the electric resistance adjusting layer 104 is remarkable. For this reason, the uneven discharge is easily caused. The present inventors have found that if the charging member 101 is used for a long period of time, the uneven discharge is caused under environment in addition to the low-temperature and low-humidity environment.

The present inventors also have found that, on the other hand, if the perchlorate and the fluorine-containing organic anion salt are added, the decrease in the conductive property by the power distribution is small. Therefore, even if the charging member 101 is used for a long period of time, a high discharge margin is maintained and the uneven discharge is not caused.

As for the electrolyte salt, the smaller an ionic radius of cation the easier the movement of ion, and the conductive property of the electric resistance adjusting layer 104 is improved. Accordingly, the perchlorate and the fluorine-containing organic anion salt are suitable. An organic phosphonium salt having a large cation can not be used. When plural series of salt are added, if the perchlorate and the fluorine-containing organic anion salt are dispersed in the polymer composition, these does not block the conductive path, respectively. Therefore, the present inventors have found that a high conductive property is obtained by adding plural series of salt even if the total blending quantity of salt is the same. Accordingly, a significant effect can be obtained even if the additive amount of each salt is small.

As the perchlorate, general salt can be used, but it is preferable to use salt selected from alkali metal salt or alkaline earth metal salt, considering the conductive property. It is more preferable to use lithium perchlorate or sodium perchlorate.

As the fluorine-containing organic anion salt, it is preferable to use salt including anion having a fluoro group and a sulfonyl group. As for the salt having the above anion, the electric charge is not localized by a strong suction effect by the fluoro group (—F) and the sulfonyl group (—SO2-), so the anion presents a high dissociation degree in the stable polymer composition, and a high ion-conductive property can be achieved. It is more preferable to use alkali metal salt of bis(fluoroalkylsulfonyl)imide, alkali metal salt of tris(fluoroalkylsulfonyl)methide, and alkali metal salt of fluoroalkylsulfonate because the decrease in the resistance value can be easily achieved.

More particularly, the fluorine-containing organic anion salt includes, for example, bis(trifluoromethanesulfonyl)imide lithium (Li(CF3SO2)2N), bis(trifluoromethanesulfonyl)imide potassium (K(CF3SO2)2N), bis(trifluoromethanesulfonyl)imide sodium (Na(CF3SO2)2N), tris(trifluoromethanesulfonyl)methide lithium (Li(CF3SO2)3C), tris(trifluoromethanesulfonyl)methide potassium (K(CF3SO2)3C), tris(trifluoromethanesulfonyl)methide sodium (Na(CF3SO2)3C), trifluoromethanesulfonatelithium (Li(CF3SO2)), trifluoromethanesulfonatepotassium (K(CF3SO3)), and trifluoromethanesulfonatesodium (Na(CF3SO3)). Especially, it is preferable to use lithium salt having a high conductive degree such as trifluoromethanesulfonatelithium, bis(trifluoromethanesulfonyl)imide lithium, or tris(trifluoromethanesulfonyl)methide lithium. By using the above-described lithium salt having a high conductive property for the electric resistance adjusting layer 104, the electric resistance adjusting layer 104 can obtain a further improved discharge margin.

By adding the perchlorate and the fluorine-containing organic anion salt into the high-molecular form ion-conductive member and kneading them, it is possible to blend at a predetermined rate, and one or more electrolyte salt for each can be added.

As the high-molecular form ion-conductive material containing the electrolyte salt, for example, IRGASTAT P18 made by Chiba Specialty Chemicals can be used. As the high-molecular form ion-conductive material containing the fluorine-containing organic anion salt, for example, SANCONOL series made by Sanko Chemical Co., Ltd. can be used. It is preferable for the blending quantity of salt to be blend at a rate of 0.01-20 weight % in the high-molecular form ion-conductive material. If the blending amount is lower than the 0.01 weight %, a sufficient conductive property can not be obtained. If the blending amount is higher than 20 weight %, it becomes difficult to uniformly disperse in a resin composition. It is preferable for the volume resistivity value of the electric resistance adjusting layer 104 to be 10⁶ Ωcm-10⁹ Ωcm. If the volume resistivity value is larger than 10⁹ Ωcm, a sufficient charging performance and a sufficient transfer performance can not be obtained. If the volume resistivity value is lower than 10⁶ Ωcm, the leak is caused by the voltage concentration to the entire photoconductor.

The conductive member for use in the present invention requires a machining process such as a cutting process or a grinding process, so as to achieve a highly accurate component. It is difficult to conduct the machining process to polyamide elastomer and polyolefin block polymer because these are soft.

Accordingly, it is possible to blend these resins with another thermoplastic resin (B) having a hardness higher than these resins. If the hardness is increased, the machining process performance is improved.

A thermoplastic resin (B) having a high hardness is not especially limited. However, it is preferable to use general purpose resin such as polyethylene (PE), polypropylene (PP), polymethacrylmethacrylate (PMMA), or polystyrene (PS) and the copolymer of the polystyrene (AS, ABS), or engineering plastic such as polycarbonate or polyacetal because they are easily molded.

The blending quantity can be set according to a target machining process within a range which does not disturb the conductive property of the electric resistance adjusting layer 104.

In order to improve the conductive property of the electric resistance adjusting layer 104, the selection of a conductive resin material and electrolyte salt, and also the control of a dispersion state are important. When the dispersion state of the electrolyte salt is rough, the uneven discharge resulting from the dispersion state under a low-temperature and low-humidity environment is easily caused, resulting in an image error. Therefore, it is preferable to add a compatibilizer for the purpose of densifying the dispersion state.

Such a compatibilizer includes graft copolymer (C) with affinity for the thermoplastic resin (A) containing the above-described polyamide elastomer and polyolefin block polymer. In particular, graft copolymer having main chain polycarbonate resin and side chain acrylonitrile-styrene-glycidylmethacrylate copolymer is used. This graft copolymer includes side chain acrylonitrile-styrene-glycidylmethacrylate copolymer having glycidylmethacrylate component which is a reaction group of an acrylonitrile component and a styrene component.

In the glycidylmethacrylate of the reaction group, the epoxy group reacts with the ether group and the amino group of the thermoplastic resin (A) by the heating when melting and kneading the component, and the glycidylmethacrylate of the reaction group strongly chemically combines with the thermoplastic resin (A). Therefore, by adding this graft copolymer so as to function as a compatibilizer, the dispersion state of the electrolyte salt can be made uniform and densified.

Therefore, the generation of the uneven discharge associated with the dispersion error of the electrolyte salt can be prevented. By setting the amount of the graft copolymer to 1-15 weight % relative to the thermoplastic resin, the dispersion state can be densified.

When blending the thermoplastic resin (A) with the thermoplastic resin (B) having a high hardness, this graft copolymer (C) functions as a compatibilizer. The main chain polycarbonate resin includes a molecular structure having a chain of a polar group and a dioxy group, so the intermolecular attraction is very strong.

Therefore, the charging member 101 is superior in mechanical strength and creep property. Especially, it is excellent at the impact strength compared with another plastic. The main chain polycarbonate resin relatively is a low water absorption resin, so variation in volume associated with the absorption variation is less. By these structures, it is difficult for cracks to occur by the volume variation under mechanical and electronic stresses, and an environment.

The side chain acrylonitorile component and styrene component have a preferable compatibility with the thermoplastic resin (B). Accordingly, when the affinity between the thermoplastic resin (A) and the thermoplastic resin (B) is low, the graft copolymer (C) functions as the compatibilizer, and the dispersion state of the thermoplastic resin (A) and the thermoplastic resin (B) is densified. Therefore, the cracks generated on the weld portion (connected portion between the resin) of the electric resistance adjusting layer 104, which are caused by the uneven power distribution of the weld portion associated with the dispersion error of the thermoplastic resin (A) and the thermoplastic resin (B), the electrical and mechanical stress when using and the volume variations with age and environment can be controlled. As a result, a kneading series resin composition which is superior in strength together with the main chain effect can be formed.

A manufacturing method of a resin composition is not especially limited. The resin composition can be easily manufactured by melting and kneading a mixture of each material with a biaxial kneading machine or a kneader. The electric resistance adjusting layer 104 is easily formed on the conductive supporting body 106 by coating the semi-conductive resin component on the conductive supporting body 106 by means of extrusion molding or injection molding.

If the conductive member is constituted by forming only the electric resistance adjusting layer 104 on the conductive supporting body 106, the conductive property may be decreased because the toners or the toner additive agent are firmly fixed on the electric resistance adjusting layer 104. Such a problem can be prevented by forming the surface layer 105 on the electric resistance adjusting layer 104. A resistance value of the surface layer 105 is set to be larger than a resistance value of the electric resistance adjusting layer 104. The voltage concentration and abnormal discharge (leak) to a defect part of the photoconductive body can be thereby avoided. However, if the resistance value of the surface layer 105 is too high, the charging ability and the transfer ability are deteriorated. Accordingly, it is preferable for a volume resistivity of the surface layer 105 to be 1000 times or less of a volume resistivity of the electric resistance adjusting layer 104.

As a material for forming the surface layer 105, fluorine series resin, silicone series resin, polyamide resin, a polyester resin or the like is excellent in a non-adhesive performance, and is preferable in terms of preventing the fixation of the toners. The surface layer 105 is formed on the electric resistance adjusting layer 104 by melting a material of the surface layer 105 into organic solvent so as to manufacture a coating, and is formed by a coating method such as spray paint, dipping, or roll coating. It is preferable for the layer thickness to be about 10-30 μm.

Both of a single pack and a double pack can be used for the material of the surface layer 105. However, by using a double pack coating using a curing agent, an environmental resistance, a non-adhesive performance and a releasing performance can be improved. When the double pack coating is used, a method of linking and hardening resin by heating a coating layer is general. However, the electric resistance adjusting layer 104 is a thermoplastic resin, so it can not be heated at a high temperature. As the double pack coating, it is effective to use base resin having a hydroxyl group in the molecule and isocyanate series resin which sets off a cross-linking reaction with a hydroxyl.

By using an isocyanate series resin, the cross-linking and hardening reaction occur at a relatively low temperature of 100° C. or less. As a result of considering the non-adhesive performance of the toners, it is confirmed that the isocyanate resin is silicone series resin and has a high non-adhesive performance of toners. Especially, acrylic silicone resin having an acrylic skeleton in the molecule is preferable.

An electric characteristic (resistance value) is important for the conductive member, so it is necessary for the surface layer 105 to have a conductive property. The conductive property can be formed by dispersing a conductive agent in the resin material. The conductive performance is not especially limited, and includes, for example, conductive carbon such as Ketjenblack EC or acetylene black, rubber carbon such as SAF, ISAF, HAF, FEF, GPF, SRF, FT, or MT, color carbon applied with an oxidization treatment and the like, pyrolytic carbon, metal such as indium-doped tin oxide (ITO), tin oxide, titanium oxide, zinc oxide, copper, silver, or germanium, and conductive polymer such as metallic oxide, polyaniline, polypyrrole, or polyacetylene. In addition, a conduction application material includes an ion-conductive substance, an inorganic ion-conductive substance such as sodium perchlorate, lithium perchlorate, potassium perchlorate or lithium chloride, and an organic ion-conductive substance such as quaternary phosphonium salt, for example, ethyltriphenylphosphonium•tetrafluoroborate, and tetraphenylphosphonium•bromide, modified fatty acid dimethyl ammonium ethosarfate, stearic ammonium acetate, or lauryl ammonium acetate.

Hereinafter, specific embodiments of the present invention will be described.

### Embodiment 1

A resin composition (volume resistivity value: 2×10⁸ Ωcm) in which the following prescription 1 is melted and kneaded at 220° C. is coated on a core shaft 106 (8 mm outer diameter) which is a conductive supporting body made of stainless-steel by means of injection molding, and an electric resistance adjusting layer 104 is formed.

Prescription 1

A-1: IRGASTAT P18 (made by Chiba Specialty Chemicals, Inc.) 30 pts.wt.

A-2: TPAE-H151 (made by FUJI KASEI KOGYO CO., LTD.) 30 pts.wt. (above, polyamide elastomer, A-1 contains perchlorate)

B: ABS resin (DENKA ABS, GR-0500 made by DENKI KAGAKU KOGYO KABUSHIKI KAISHA) 40 pts.wt.

With respect to 100 pts.wt. of mixture of A-1, A-2, and B,

C: polycarbonate-glycidylmethacrylate-styrene-acrylonitrile copolymer (MODIPER CL440-G made by NOF CORPORATION) 4.5 pts.wt. (graft copolymer)

D: trifluoromethanesulfonatelithium (LiTFE made by Morita Chemical Industries Co., Ltd.) 3 pts.wt. (fluorine-containing organic anion salt)

Next, ring-shaped space holding members 103 made of high-density polyethylene resin (NOVATEC HD HY540 made by Japan Polyethylene Corporation) are provided in both end portions of the electric resistance adjusting layer 104, respectively, and the core shaft 106 and the electric resistance adjusting layer 104 are bonded.

Next, the outer diameter (the maximum diameter) of the space holding member 103 and the outer diameter of the electric resistance adjusting layer 104 are simultaneously finished to 12.12 mm and 12.00 mm, respectively, by a cutting process.

Next, a surface layer 105 having a layer thickness of about 10 μm by a mixture (surface resistance: 2×10⁹Ω) made of acylic silicone resin (3000VH-P made by Kawakami Paint, Inc.), isocyanate series resin, and carbon black (35 pts.wt relative to the total dissolved solid) is formed on the surface of the electric resistance adjusting layer 104, and a conductive member 101 is obtained through a calcinations process.

### Embodiment 2

A resin composition (volume resistivity value: 2×9 Ωcm) in which the following prescription 2 is melted and kneaded at 220° C. is coated on a core shaft 106 (8 mm outer diameter) made of stainless-steel by means of injection molding, and an electric resistance layer 104 is formed.

Prescription 2

A-1: IRGASTAT P18 (made by Chiba Specialty Chemicals, Inc.) 30 pts.wt.

A-2: TPAE-H151 (made by FUJI KASEI KOGYO CO., LTD.) 30 pts.wt.

(above, polyamide elastomer, polyolefin block polymer, A-1 contains perchlorate)

B: ABS resin (DENKA ABS, GR-0500 made by DENKI KAGAKU KOGYO KABUSHIKI KAISHA) 40 pts.wt.

With respect to 100 pts.wt. of mixture of A-1, A-2, and B,

C: polycarbonate-glycidylmethacrylate-styrene-acrylonitrile copolymer (MODIPER CL440-G made by NOF CORPORATION) 4.5 pts.wt. (graft copolymer)

D: bis(trifluoromethanesulfonyl)imide lithium (LiTFSL made by Morita Chemical Industries Co., Ltd.) 1 pts.wt (fluorine-containing organic anion salt).

A conductive member 101 was obtained through the post-processes which are the same as the processes in the embodiment 1.

### Embodiment 3

A resin composition (volume resistivity value: 3×10⁸ Ωcm) in which the following prescription 3 is melted and kneaded at 230° C. is coated on a core shaft 106 (8 mm outer diameter) made of stainless-steel by means of injection molding, and an electric resistance layer 104 is formed.

Prescription 3

A-1: Sankonol TBX-65 (made by Sanko Chemical Ind, Co., Ltd.) 70 pts.wt. (above polyamide elastomer, A-1 contains trifluoromethanesfonatelithium).

B: polycarbonate resin (Iupilon H-4000 made by Mitsubishi Engineering-Plastics Corporation) 30 pts.wt.

With respect to 100 pts.wt. of mixture of A-1 and B,

C: polycarbonate-glycidylmethacrylate-styrene-acrylonitrile copolymer (MODIPER CL440-G made by NOF CORPORATION) 4.5 pts.wt. (graft copolymer)

D: lithium perchlorate (made by Mitsuwa Chemicals Co., Ltd.) 3 pts.wt. (perchlorate)

A conductive member 101 is obtained through the post-processes which are the same as the processes in Embodiment 1.

### Embodiment 4

A resin composition (volume resistivity value: 4×10⁸ Ωcm) in which the following prescription 4 is melted and kneaded at 220° C. is coated on a core shaft 106 (8 mm outer diameter) made of stainless-steel by means of injection molding, and an electric resistance layer 104 is formed.

Prescription 4

A-1: IRGASTAT P18 (made by Chiba Specialty Chemicals) 30 pts.wt.

A-2: Sankonol TBX-310 (made by Sanko Chemical Ind, Co., Ltd.) 30 pts.wt. (above polyamide elastomer, polyolefin block polymer, A-1 contains perchlorate and A-2 contains trifluoromethanesfonatelithium).

B: ABS resin (DENKA ABS GR-0500 made by DENKI KAGAKU KOGYO) 40 pts.wt.

With respect to 100 pts.wt of mixture of A-1, A-2 and B,

C: polycarbonate-glycidylmethacrylate-styrene-acrylonitrile copolymer (MODIPER CL440-G made by NOF CORPORATION) 9 pts.wt. (graft copolymer)

A conductive member 101 is obtained through the post-processes which are same as the processes in Embodiment 1.

### Embodiment 5

A resin composition (volume resistivity value: 3×10⁸ Ωcm) in which the following prescription 5 is melted and kneaded at 220° C. is coated on a core shaft 106 (8 mm outer diameter) made of a stainless-steel by means of injection molding, and an electric resistance layer 104 is formed.

Prescription 5

A-1: Pebax MV1041 (made by ARKEMA) 60 pts.wt. (above polyamide elastomer).

B: HI-PS resin (H450 made by Toyo Styrene Co., Ltd.) 40 pts.wt.

With respect to 100 pts.wt. of mixture of A-1 and B,

C: polycarbonate-glycidylmethacrylate-styrene-acrylonitrile copolymer (MODIPER CL440-G made by NOF CORPORATION) 4.5 pts.wt. (graft copolymer).

D: lithium perchlorate (made by Mitsuwa Chemicals Co., Ltd.) 3 pts.wt. (perchlorate)

bis(pentafluoroethanesulfonyl)imide lithium (LiBETL made by Kishida Chemical Co., Ltd.) 1 pts.wt. (fluorine-containing organic anion salt).

A conductive member 101 is obtained through the post-processes which are the same as the processes in Embodiment 1.

### COMPARATIVE EXAMPLE 1

A core shaft (8 mm outer diameter) made of stainless-steel is coated by means of injection molding without melting and kneading the following prescription 6, and an electric resistance adjusting layer is formed.

Prescription 6

A-1: IRGASTAT P18 (made by Chiba Specialty Chemicals) 30 pts.wt. (above, polyamide elastomer, A-1 contains perchlorate).

B: ABS resin (DENKA ABS GR-3000 made by DENKI KAGAKU KOGYO) 40 pts.wt.

A conductive member is obtained through the post-processes which are the same as the processes in Embodiment 1.

### COMPARATIVE EXAMPLE 2

A core shaft (8 mm outer diameter) made of stainless-steel is coated by means of injection molding without melting and kneading the following prescription 7, and an electric resistance adjusting layer is formed.

Prescription 7

A-1: Pebax 5533 (made by ARKEMA) 60 pts.wt. (above, polyamide elastomer, A-1 contains perchlorate)

B: ABS resin (DENKA ABS GR-3000 made by DENKI KAGAKU KOGYO) 40 pts.wt.

Relative to 100 pts.wt. of mixture of A-1 and B,

D: ETPP-1 (made by Nippon Chemical Industrial CO., LTD.) 3 pts.wt. (organic phosphonium salt)

A conductive member is obtained through the post-processes which are the same as the processes in Embodiment 1.

### COMPARATIVE EXAMPLE 3

A core shaft (8 mm outer diameter) made of stainless-steel is coated by means of injection molding without melting and kneading the following prescription 8, and an electric resistance adjusting layer is formed.

Prescription 8

A-1: polyethylene oxide (adekapolyether P-400 made by ADEKA corporation) 20 pts. wt. (above, polyether polyols)

B: ABS resin (TECHNO made by Techno Polymer) 80 pts.wt.

Relative to 100 pts.wt. of mixture of A-1 and B,

D: Lithium perchlorate (made by Mitsuwa Chemicals Co., Ltd.) 2 pts.wt. (perchlorate)

trifluoromethanesulfonatelithium (LiTFS made by Morita Chemical Industries Co., Ltd.) 3 pts.wt. (fluorine-containing organic anion salt).

A conductive member is obtained through the post-processes which are the same as the processes in Embodiment 1.

### COMPARATIVE EXAMPLE 4

A resin composition, which is obtained by heating the following prescription 8 at 70° C. and next depressurizing and dehydrating without melting and kneading, is coated on a core shaft (8 mm outer diameter) made of stainless-steel by means of injection molding, and an electric resistance adjusting layer is formed.

Prescription 8

A-1: polypropylene oxide (Excenol 2020 made by Asahi Glass Co., Ltd.) 30 pts.wt. (above, polyether polyols)

B: ABS resin (TECHNO ABS110 made by Techno Polymer) 70 pts.wt.

Relative to 100 pts.wt. of mixture of A-1 and B,

D: Lithium perchlorate (made by Mitsuwa Chemicals Co., Ltd.) 3 pts.wt. (perchlorate)

bis(trifluoromethanesulfonyl)imide lithium (LiTFSL made by Morita Chemical Industries Co., Ltd.) 1 pts.wt. (fluorine-containing organic anion salt).

A conductive member is obtained through the post-processes which are the same as the processes in Embodiment 1.

Table 1 illustrates the structures of the embodiments and the comparative examples.

TABLE 1

| | | Electric Resistance Adjusting Layer | | | | |
|---|---|---|---|---|---|---|
| | | polyamide | polyamide | resin (B) | | Surface layer |
| | | elastomer, | elastomer, | having a | | perchlorate/ |
| | | polyolefin | polyolefin | hardness | | fluorine-containing |
| | | block polymer | block polymer | higher | Graft copolymer | organic anion salt |
| | | (A-1) | (A-2) | than (A) | (C) | (D) |
| Embodiment 1 | Material | IRGASTAT | TPAE-H151 | ABS | Modiper CL440G | LiTFS |
| | | P-18 | | GR-0500 | | |
| | | (contain Na) | | | | |
| | Blending | 30 pts. wt. | 30 pts. wt. | 40 pts. wt. | 4.5 pts. wt. | 3 pts. wt. relative |
| | Quantity | | | | relative to 100 pts. | to 100 pts. wt. of A + B |
| | | | | | wt. of A + B | |
| Embodiment 2 | Material | IRGASTAT | TPAE-10HP | ABS | same as above | LiTFSI |
| | | P-18 | | GR-0300 | | |
| | | (contain Na) | | | | |
| | Blending | 30 pts. wt. | 30 pts. wt. | 40 pts. wt. | same as above | 1 pts. wt. relative to |
| | Quantity | | | | | 100 pts. wt. of A + B |
| Embodiment 3 | Material | TBX-65 | none | PC | same as above | perchlorate Li |
| | | (contain LiTFS) | | H-4000 | | |
| | Blending | 70 pts. wt. | — | 30 pts. wt. | same as above | 3 pts. wt. relative to |
| | Quantity | | | | | 100 pts. wt. of A + B |
| Embodiment 4 | Material | IRGASTAT | TBX-310 | ABS | same as above | none |
| | | P-18 | (contain LiTFS) | GR-0500 | | |
| | | (contain Na) | | | | |
| | Blending | 30 pts. wt. | 30 pts. wt. | 40 pts. wt. | 9 pts. wt. relative to | — |
| | Quantity | | | | 100 pts. wt. of A + B | |
| Embodiment 5 | Material | MV1041 | none | HI-PS | same as above | perchlorate Li |
| | | | | H450 | | LiBETI |
| | Blending | 60 pts. wt. | — | 40 pts. wt. | 4.5 pts. wt. relative to | 3 pts. wt. relative to |
| | Quantity | | | | 100 pts. wt. of A + B | 100 pts. wt. of A + B |
| Comparative | Material | IRGASTAT | none | ABS | none | 1 pts. wt. |
| Example 1 | | P-18 | | GR-0300 | | none |
| | | (contain Na) | | | | |
| | Blending | 60 pts. wt. | — | 40 pts. wt. | — | — |
| | Quantity | | | | | |
| Comparative | Material | 5533 | none | ABS | none | ETPP-I |
| Example 2 | | | | GR-0500 | | |
| | Blending | 60 pts. wt. | — | 40 pts. wt. | — | 3 pts. wt. relative to |
| | Quantity | | | | | 100 pts. wt. of A + B |
| Comparative | Material | PEO | none | ABS | none | perchlorate Li |
| Example 3 | | | | Techno 170 | | LiTFS |
| | Blending | 20 pts. wt. | — | 80 pts. wt. | — | 2 pts. wt., 3 pts. wt. relative |
| | Quantity | | | | | to 100 pts. wt. of A + B |
| Comparative | Material | PPO | none | ABS | none | perchlorate Li |
| Example 4 | | | | Techno 110 | | LiTFSI |
| | Blending | 30 pts. wt. | — | 70 pts. wt. | — | 3 pts. wt., 1 pts. wt. relative |
| | Quantity | | | | | to 100 pts. wt. of A + B |

### [Test 1]

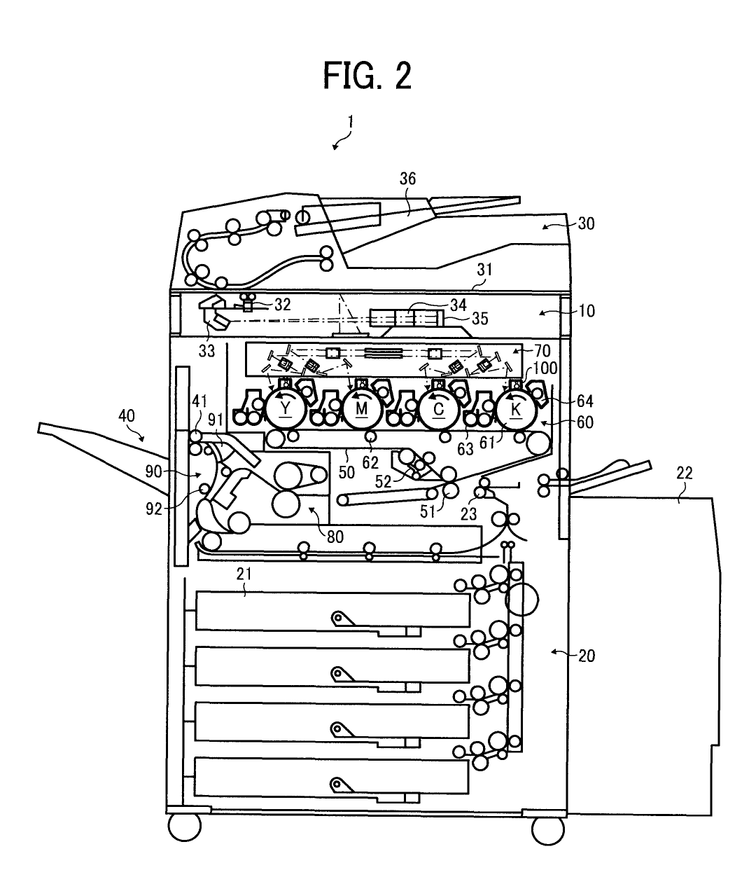

After leaving the conductive member 101 described in each of the embodiments 1-5 and the comparative examples 1-4 for 3 days in a low-temperature and low-humidity environment (10° C. 15% RH), the resistance measurement of the conductive member 101 is evaluated. Next, an image is evaluated by using the image forming device 1 illustrated in FIG. 2 in a low-temperature and low-humidity environment (10° C. 15% RH). The voltage to be applied to the charging roller 101 is DC=−600V and ACVpp=2.2 kV (frequency=2.2 kHz), and image error by uneven discharge is evaluated.

Table 2 illustrates the evaluation results.

TABLE 2

| | Resistance Value | Image Error | |
|---|---|---|---|
| | 100 V (Ω) | by Uneven Discharge | Evaluation |
| Embodiment1 | 2.5E+05 | nonexistence | OK |
| Embodiment2 | 4.0E+05 | nonexistence | OK |
| Embodiment3 | 1.0E+06 | nonexistence | OK |
| Embodiment4 | 7.9E+05 | nonexistence | OK |
| Embodiment5 | 5.8E+05 | nonexistence | OK |
| Comparative | 1.3E+08 | existence | NG |
| Example 1 | | | |
| Comparative | 1.9+E11 | image can not be output | NG |
| Example 2 | | | |
| Comparative | 2.8E+09 | existence | NG |
| Example 3 | | | |
| Comparative | 7.7E+08 | existence | NG |
| Example 4 | | | |

The charging roller 101 according to each of the embodiments has a high conductive property and a low resistance. Therefore, a preferable image is obtained by using the charging roller 101 according to each of the embodiments. However, the charging roller according to each of the comparative examples has a low conductive property and a high resistance. Therefore, an image error by uneven discharge is caused. The charging roller of the comparative example 2 has an extremely high resistance, so an image could not be output.

### [Test 2]

Next, a driving test of a charging roller without passing through a recording medium is conducted for 120 hours (corresponding to the copy of 1500 sheets) in an evaluation environment (23° C., 50% RH) by using an acceleration test device in which the image forming device 1 illustrated in FIG. 2 is converted. After that, the resistance is measured in a low-temperature and low-humidity environment (10° C. 15% RH), and the resistance variations before and after power distribution are examined. In this case, the voltage to be applied to the charging roller is DC=−700V, ACVpp=2.7 kV (frequency=3 kHz). Next, an image is evaluated similar to the test 1 in evaluation environment (10° C. 15% RH).

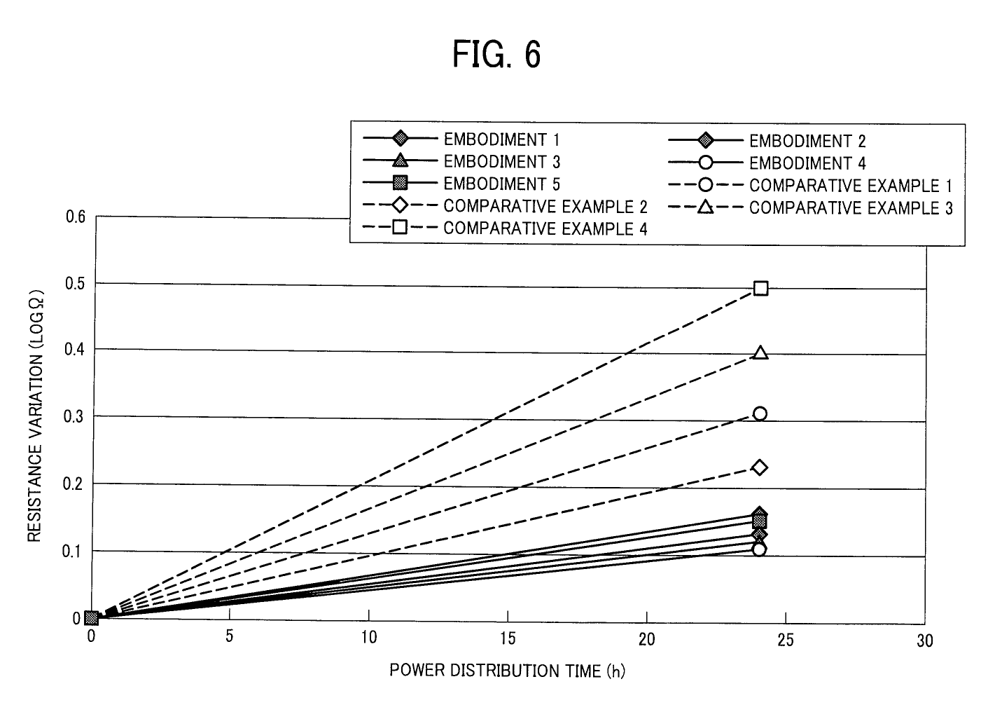

Table 3 and FIG. 6 illustrate the results of the test.

TABLE 3

| | Resistance | | |
|---|---|---|---|
| | Variation | Image Error | |
| | LOGΩ | by Uneven Discharge | Evaluation |
| Embodiment1 | 0.16 | nonexistence | OK |
| Embodiment2 | 0.13 | nonexistence | OK |
| Embodiment3 | 0.12 | nonexistence | OK |
| Embodiment4 | 0.11 | nonexistence | OK |
| Embodiment5 | 0.15 | nonexistence | OK |
| Comparative | 0.31 | existence | NG |
| Example 1 | | | |
| Comparative | 0.40 | image can not be output | NG |
| Example 2 | | | |
| Comparative | 0.23 | existence | NG |
| Example 3 | | | |
| Comparative | 0.50 | existence | NG |
| Example 4 | | | |

Since the roller of each of the embodiments has small resistance variations, a preferable image is obtained in the image evaluation after power distribution. However, since the roller of each of the comparative examples has large resistance variations, an image error is caused.

The roller of the comparative example 2 has an extremely high resistance, so an image can not be output.

Comparing the present embodiments with the comparative examples, as illustrated in Table 2, they have a resistance value difference of 1.0×10² or more even in a low-temperature and low-humidity environment, and it is considered that the discharge margin of the conductive member according to the embodiments of the present invention is high. In addition, comparing the resistance variations of the present embodiments with the resistance variations of the comparative examples, as illustrated in Table 3 and FIG. 6, it is considered that the resistance variations of the conductive member according to the embodiments of the present invention are small. More particularly, in the image forming device 1 according to the embodiment of the present invention, uneven discharge is not caused, and an image error is not generated.

Since the perchlorate and the fluorine-containing organic anion salt are added to the conductive member of the image forming device 1 of the present embodiment, the decrease in the conductive property of the conductive member by the polarization of electrolyte salt in the power distribution is decreased. Even if this conductive member is used for a long period of time, the generation of the uneven discharge can be prevented.

In addition, by using at least one or more lithium salt having a high conductive property selected from a trifluoromethanesulfonatelithium, bis(trifluoromethanesulfonyl)imide lithium, and tris(trifluoromethanesulfonyl)methide lithium for the above-described fluorine-containing organic anion salt, the conductive member can obtain a high discharge margin.

By melting and kneading the thermoplastic resin (A) and the graft copolymer with an affinity for the thermoplastic resin (A), the densified dispersion state can be obtained. Accordingly, the conductive property is improved, and the image error by the uneven discharge can be prevented.

The above-described graft copolymer is a graft copolymer having main-chain polycarbonate resin and side-chain acrylonitrile-styrene-glycidyl methacrylate copolymer. By using this graft copolymer as a compatibilizer, this graft copolymer is strongly combined with the thermoplastic resin (A), so as to make uniform the dispersion state. Therefore, the conductive property is improved.

A superior image quality can be obtained for a long period of time by using the above-described conductive member as the charging member for the close charging method.

Moreover, a process cartridge, which can obtain a high image quality for a long period of time, can be obtained by using this charging member for the process cartridge.

Furthermore, an image forming device having a close charging method, which can obtain a high quality image for a long period of time, can be achieved by using this process cartridge for the image forming device.

As described above, the conductive member, the charging roller to which this conductive member is applied, the process cartridge using the charging roller, and the image forming device using the process cartridge are described in the above embodiments. However, the specific structures are not limited thereto. It should be appreciated that variations may be made in the embodiment described by persons skilled in the art without departing from the scope of the present invention as defined by the following claims

For example, the conductive member according to the embodiment of the present invention can be used as the charging roller. However, it can be applied to any device made of a material to be energized. For example, as described above, this conductive member can be applied as the transfer member, which conducts a transfer process to the toners on the photoconductive drum.

In addition, the conductive member according to the present invention is not limited to the above-described embodiment as long as it is disposed to have a space between the conductive member and the image carrier, and has an electric resistance adjusting layer which charges the image carrier by power distribution, a conductive supporting body which supports the electric resistance adjusting layer, and a space holding member which constantly retains the space between the image carrier and the electric resistance adjusting layer. The structures thereof can be appropriately changed.

Moreover, the charging roller according to the present invention is not limited to the above-described embodiment as long as it has an electric resistance adjusting layer which charges the image carrier by power distribution, a conductive supporting body which supports the electric resistance adjusting layer, and a space holding member which constantly retains the space between the image carrier and the electric resistance adjusting layer. The structures thereof can be appropriately changed.

Furthermore, the process cartridge according to the present invention is not limited to the above-described embodiment as long as it has the above-described charging roller, a developing unit which visualizes an electrostatic latent image which is formed by exposing the charged image carrier, and has the image carrier. The structures thereof can be appropriately changed.

In addition, the image forming apparatus of the present invention is not limited to the above-described embodiment as long as it has the above-described process cartridge and an exposure unit which forms an electrostatic latent image by exposing the charged image carrier. The structures thereof can be appropriately changed.

In the above embodiment, the charging member is applied to the image forming device using light (laser light). However, it can be applied to an image forming device using an electrophotographic method such as a facsimile. More particularly, it can be applied to any image forming device in which a conductive member is used when forming an image.

According to one embodiment of the present invention, the conductive member includes the conductive supporting body, the electrostatic resistance adjusting layer formed on the conductive supporting body, and the space holding member, which is formed on each of both end portions of the electric resistance adjusting layer, has a material different from a material of the electric resistance adjusting layer, and constantly maintains the space between the electric resistance adjusting layer and the image carrier, wherein the electric resistance adjusting layer includes a resin composition including thermoplastic resin containing at least polyamide elastomer and polyolefin block polymer and plural types of salt containing at least one type of salt selected from perchlorate and at least one type of salt selected from fluorine-containing organic anion salt. Therefore, the discharge margin of the conductive member is improved, and the image error by the uneven discharge can be prevented in the low-temperature and low-humidity environment.

In addition, according to one embodiment of the present invention, the fluorine-containing organic anion salt is at least one or more type of salt selected from trifluoromethanesulfonatelithium and bis(trifluoromethanesulfonyl)methide lithium. Therefore, a further improved discharge margin can be obtained by using lithium salt having a high conductive property.

Moreover, according to one embodiment of the present invention, the graft copolymer with an affinity for the thermoplastic resin is melted and kneaded. Therefore, the densified dispersion state can be obtained, and the conductive property is improved. Accordingly, an image error by the uneven discharge can be prevented.

Furthermore, according to one embodiment of the present invention, the graft copolymer is a graft copolymer including main-chain polycarbonate resin and side-chain acrylonitrile-styrene-glycidyl methacrylate copolymer. Therefore, the graft copolymer can be used as a compatibilizer, and is strongly combined with the thermoplastic resin (A) by the heating when melting and kneading. Accordingly, the dispersion state made uniform, and the conductive property is improved.

According to one embodiment of the present invention, the conductive member charges the image carrier by the close charging method. Therefore, a superior image quality can be obtained for a long period of time.

According to one embodiment of the present invention, the process cartridge includes the above-described conductive member. Therefore, a process cartridge which can obtain a superior image quality for a long period of time can be achieved.

According to one embodiment of the present invention, the image forming device includes the above-described process cartridge. Therefore, an image forming device of a close charging method which can obtain a superior image quality for a long period of time can be achieved

What is claimed is:

1. A conductive member, comprising:
a conductive supporting body;
an electrostatic resistance adjusting layer formed on the conductive supporting body; and
a space holding member, which is formed on each of both end portions of the electric resistance adjusting layer, has a material different from a material of the electric resistance adjusting layer, and constantly maintains a space between the electric resistance adjusting layer and the image carrier, wherein
the electric resistance adjusting layer comprises a resin composition including thermoplastic resin containing at least polyamide elastomer and polyolefin block polymer and plural types of salt containing at least one type of salt selected from perchlorate and at least one type of salt selected from fluorine-containing organic anion salt.

2. The conductive member according to claim 1, wherein the fluorine-containing organic anion salt is at least one or more type of salt selected from trifluoromethanesulfonatelithium, bis(trifluoromethanesulfonyl)imide lithium, and tris(trifluoromethanesulfonyl)methide lithium.

3. The conductive member according to claim 1, wherein graft copolymer with an affinity for the thermoplastic resin is melted and kneaded.

4. The conductive member according to claim 2, wherein graft copolymer with an affinity for the thermoplastic resin is melted and kneaded.

5. The conductive member according to claim 1, wherein the graft copolymer is a graft copolymer including main-chain polycarbonate resin and side-chain acrylonitrile-styrene-glycidyl methacrylate copolymer.

6. The conductive member according to claim 1, wherein the conductive member charges the image carrier.

7. A process cartridge comprising the conductive member set forth in claim 6.

8. An image forming device comprising the process cartridge set forth in claim 7.
